(19) United States
(12) Patent Application Publication
(10) Pub. No.: US 2019/0183108 A1
(43) Pub. Date: Jun. 20, 2019

(54) Rope Apparatus to Deter Maritime Birds and Rodents

(71) Applicants: Michael J. Slevens, Pearland, TX (US); Sharon Green, Mt. Arlington, NJ (US)

(72) Inventors: Michael J. Slevens, Pearland, TX (US); Sharon Green, Mt. Arlington, NJ (US)

(21) Appl. No.: 16/226,653

(22) Filed: Dec. 20, 2018

Related U.S. Application Data
(60) Provisional application No. 62/608,135, filed on Dec. 20, 2017.

(51) Int. Cl. A01M 29/06

(52) U.S. Cl. CPC A01M 29/06; A01M 31/06

(57) ABSTRACT

The present invention provides a rope apparatus to deter maritime birds and rodents comprising a snakehead device, a receptacle and a means for firmly attaching the receptacle to a rope.

### CROSS-REFERENCE TO RELATED APPLICATIONS

This application claims the benefit of, and priority to, pending U.S. Provisional Application No. 62/608,135 filed Dec. 20, 2017 titled “Rope Apparatus to Deter Maritime Birds and Rodents.”

### FIELD OF THE INVENTION

This invention relates generally to guarding and fright producing devices and specifically to maritime bird and rodent deterrent devices.

### BACKGROUND OF THE INVENTION

Bird and rodent deterrents have long been utilized to protect boats, docks and other maritime areas from damages caused by such animals. These animals cause damage by their perching, nesting, roosting and defecation. Further, the droppings of such animals can serve as fertile breeding grounds for disease and illness causing bacteria.

Modern devices to scare and deter birds, rodents and other animals include a number of mechanical devices such as U.S. Pat. Nos. 9,339,024, 8,869,467 and 8,443,543. Other devices include scare inducing electronic mechanisms such as U.S. Pat. Nos. 3,416,266 and 7,249,436. However, all these devices can be cumbersome to install or maintain, particularly when docking a boat for a short period of time. Further electronic devices are not well suited for a maritime environment.

Historically, one of the oldest manners by which sailors would protect their boats and property from birds and rodents was to leave coils of ropes on docks, gunwales, decks and other surfaces. In this manner, the rope resembled a coiled snake ready to strike. Such ropes would operate as a deterrent. While this is a simple and easy method to employ a bird and rodent deterrent, the coiled rope simply resembles the body of a snake and not the most menacing feature of the predator: its head.

The purpose of the present invention is to address the needs for an easily deployed device to deter birds, rodents and other animals in a maritime environment.

### SUMMARY OF THE INVENTION

The present invention provides a device that when used resembles a predatory snake. The device is comprised of a proximal end and a distal end. The distal end of the device resembles a snake head. At the proximal end of the device is a hollow receptacle. When employed, the receptacle receives a rope or line. Within the receptacle is a means to firmly attach a rope or line.

### BRIEF DESCRIPTION OF DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a right side view of the present invention

FIG. 2 illustrates a left side view of the present invention

FIG. 3 illustrates a view of the distal end of the present invention.

FIG. 4 illustrates a view of the proximal end of the present invention.

FIG. 5 illustrates a top view of the present invention.

FIG. 6 illustrates a top view of present invention engaged with a rope.

FIG. 7 illustrates a rear aspect view of the present invention.

FIG. 8 illustrates a top view of the present invention.

FIG. 9 illustrates a front aspect view of the present invention.

FIG. 10 illustrates a top view of the present invention.

### DETAILED DESCRIPTION OF THE PREFERRED EMBODIMENT

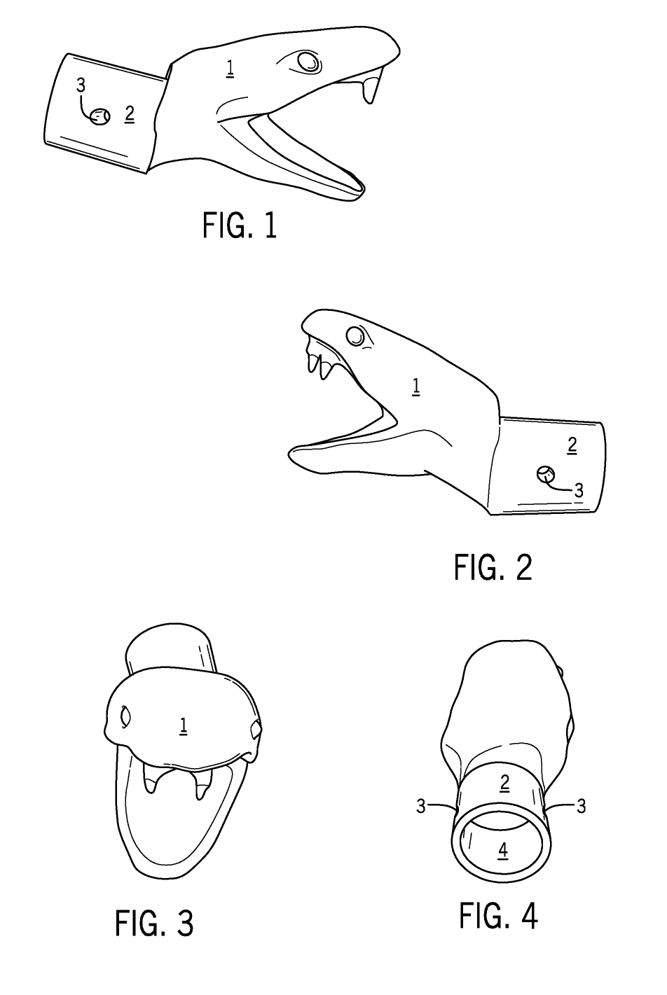

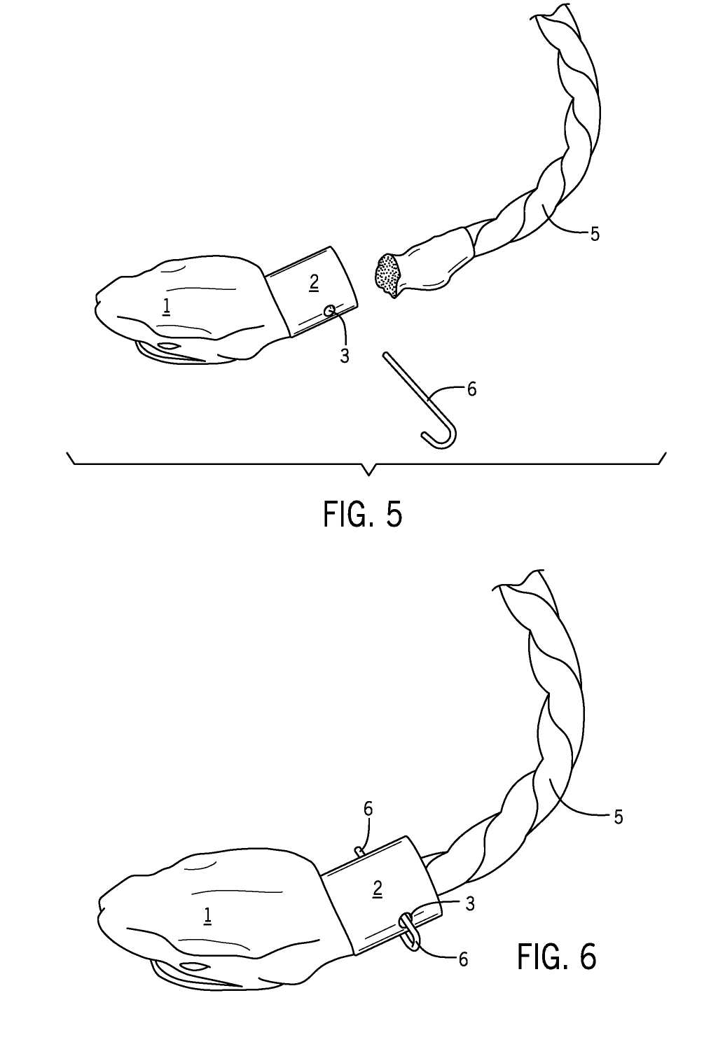

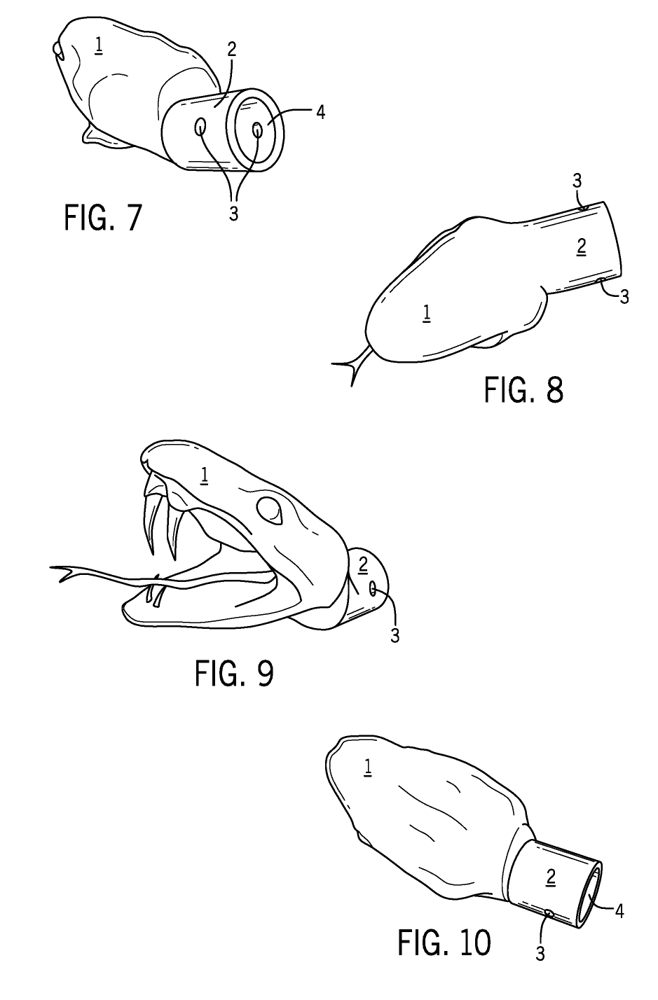

The following provides a detailed description of the preferred embodiment with reference to the drawings, in which similar reference characters denote similar elements throughout the several views. FIGS. 1 through 10 illustrate a device to deter maritime birds, rodents and other animals comprising a distal end 1 which resembles a snake head and a proximal end 2. The proximal end 2 has a hollow receptacle 4. The receptacle 4 contains a means to firmly attach a rope or line 5. In the preferred embodiment, the means to firmly attach a rope or line 5 is made from dual holes 3 within the walls of the receptacle 4 through which a pin 6 can pass through one side of the receptacle 4, through the rope 5 and through the opposing side of the receptacle 4. However, in other embodiments different means of attachment may be utilized. These include, by way of example (and not as a limitation), a cotter pin, a clevis pin, a hook, a spring, a bolt, a screw or a friction fitting.

In the preferred embodiment, the distal end 1 snakehead is a highly detailed replica of a rattlesnake head with its jaws agape. In other embodiments, replicas of other species of snake are used and in different anatomical configurations. In the preferred embodiment the hollow receptacle 4 is cylindrical. The receptacle 4 may be shaped in a different manner in other embodiments.

Although particular embodiments of the present disclosure have been described, it is not intended that such references be construed as limitations upon the scope of this disclosure except as set forth in the claims.

We claim:

1. A device to deter maritime birds, rodents and other animals comprising:
a) A distal end resembling the head of a snake;
b) A proximal end with a receptacle;
c) A means for firmly attaching a rope to the receptacle.

2. A device to deter maritime birds, rodents and other animals comprising:
a) A distal end resembling the head of a snake;
b) A proximal end with a receptacle;
c) At least one hole in the side of the receptacle.

3. A device as recited in claim 2, further comprising a pin that passes through said hole and into a rope.
